(19) United States
(12) Patent Application Publication
(10) Pub. No.: US 2006/0013258 A1
(43) Pub. Date: Jan. 19, 2006

(54) System, apparatus and method of improving network data traffic between interconnected high-speed switches

(75) Inventors: Dwip N. Banerjee, Austin, TX (US); Kavitha Vittal Murthy Baratakke, Austin, TX (US); Lilian Sylvia Fernandes, Austin, TX (US); Venkat Venkatsubra, Austin, TX (US)

Correspondence Address: IBM CORPORATION (VE);C/O VOLEL EMILE, P. O. BOX 202170, AUSTIN, TX, 78720-2170, US

(73) Assignee: International Business Machines Corporation

(21) Appl. No.: 10/889,784

(22) Filed: Jul. 13, 2004

(51) Int. Cl. H04J 3/24

(52) U.S. Cl. 370/474

(57) ABSTRACT

A system, apparatus and method of improving network data traffic between interconnected high-speed switches are provided. As is well known, when a packet of data is longer than a path maximum transmission unit (PMTU), the packet will be fragmented. In the case of the invention, the packet is fragmented by a transmitting router connected to a high-speed switch. When a receiving router, which is also connected to an high-speed switch, begins to receive the fragments, it will check to see whether its sub-network may handle data of a substantially longer length than the length of the fragments. If so, the receiving router will collect the fragments, reassemble them into the original packet and transmit the reassembled packet to its destination.

### BACKGROUND OF THE INVENTION

1. Technical Field

The present invention is directed to network communications. More specifically, the present invention is directed to a system, apparatus and method of improving network data traffic between interconnected high-speed switches.

2. Description of Related Art

With the advent of high bandwidth-consuming applications such as on-line content, e-commerce, network databases, streaming media etc., Scalable POWER_Parallel (SP) systems are increasingly being used. An SP system is a distributed parallel data processing system that incorporates a central switch. The central switch (or SP switch) is a high-speed switch that is used to provide a high efficiency interconnection of processor nodes. (SP systems and SP switches are products of IBM Corporation.) Particularly, a high-speed switch such as an SP switch may support Maximum Transmission Units (MTUs) as large as 64 kbytes (i.e., packets of 64 kbytes). By contrast, an ordinary Ethernet connection may support an MTU of 1500 bytes (i.e., packets of 1500 bytes). An MTU is the maximum size of a packet that an intermediate link can process without fragmenting the packet. Thus, each data transaction between any two nodes of an SP switch may be of 64 kbytes long. However, when two SP switches are interconnected via an ordinary Ethernet fabric, the data packets may not exceed 1500 bytes. This is a rather drastic loss of performance.

What is needed, therefore, is a system, apparatus and method of improving network data traffic between interconnected high-speed switches.

### SUMMARY OF THE INVENTION

The present invention provides a system, apparatus and method of improving network data traffic between interconnected high-speed switches. As is well known, when a packet of data is longer than a path maximum transmission unit (PMTU), the packet will be fragmented. In the case of the invention, the packet is fragmented by a transmitting router connected to a high-speed switch. When a receiving router, which is also connected to an high-speed switch, begins to receive the fragments, it will check to see whether its sub-network may handle data of a substantially longer length than the length of the fragments. If so, the receiving router will collect the fragments, reassemble them into the original packet and transmit the reassembled packet to its destination.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts an exemplary SP system.

FIG. 2 depicts a conceptual view of FIG. 1.

FIG. 3 depicts a network of two SP systems that is based on an Ethernet interconnect.

FIG. 4 is a flowchart of a process that may be used to implement the invention.

FIG. 5 depicts a representative IP header in byte format.

FIG. 6 is an exemplary block diagram of a computer system according to the present invention.

### DETAILED DESCRIPTION OF THE PREFERRED EMBODIMENT

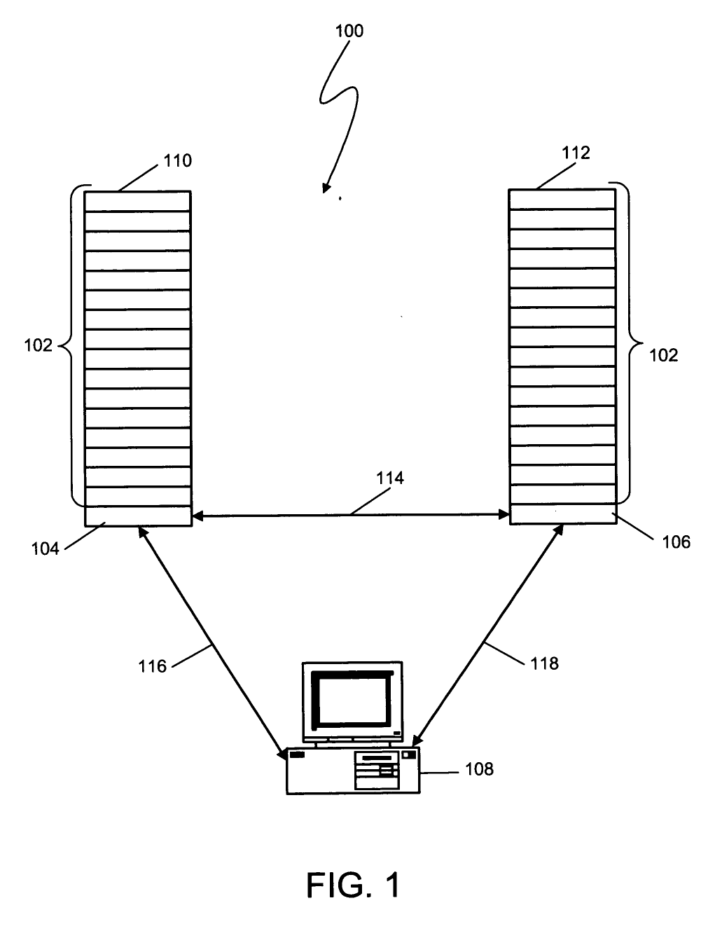

With reference now to the figures, FIG. 1 depicts an exemplary SP system. The exemplary SP system contains two frames 110 and 112 and a control workstation 108. The two frames 110 and 112 contain each 16 nodes (i.e., nodes 102) and an SP switch (switches 104 and 106). The two frames 110 and 112 are connected to each other by switch-to-switch cable 114 and are each connected to the control workstation 108 by a serial cable (i.e., cables 116 and 118).

Note that a frame is a containment unit consisting of a rack to hold workstations, together with supporting hardware, including power supplies, cooling equipment and communication media such as a system Ethernet. Note further that each node 102 is a workstation packaged to fit in the SP frame. A node ordinarily is devoid of a monitor and keyboard. Therefore, access to the nodes 102 is generally through the control workstation 108. Lastly, note that although the SP system is shown to contain two frames having each 16 nodes, the invention is not thus restricted. Any SP system may be used (e.g., one or more than two-frame SP systems having more than or less than 16 nodes). Hence, the two-frame SP system is used for illustrative purposes only.

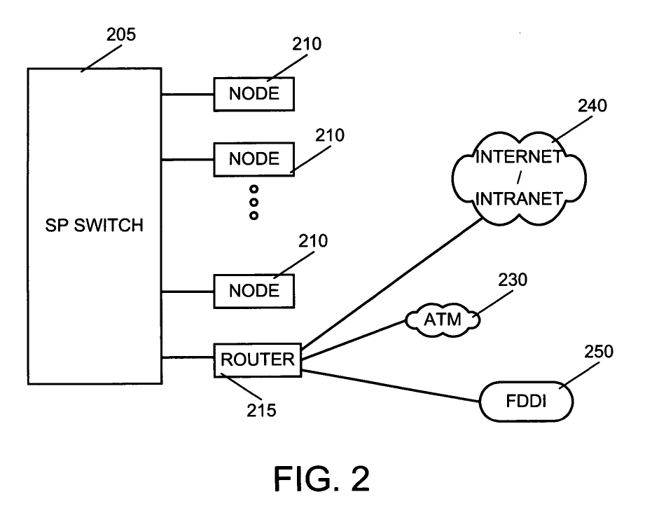

FIG. 2 depicts a conceptual view of the SP system in FIG. 1. In this figure, switch 205, which is one of the SP switches (e.g., switch 104) of FIG. 1, is shown to have a plurality of nodes 210 attached thereto. Also attached to the SP switch 205 is a router 215. The router is, for all intent and purpose, another node since it occupies a node slot. Through the router 215, the SP system may access other networks such as Asynchronous Transfer Mode (ATM) network 230, Internet/Intranet 240 and Fiber Distributed Data Interface (FDDI) network 250 etc.

As alluded to before, data packet transaction between a node 210 and another node 210 or between the router 215 and a node 210 may be 64 kbytes long. Data traffic between the SP system 100 of FIG. 1 and another SP system through FDDI 250 and ATM 230 networks may occur at an equivalent speed. However, data traffic between the SP system of FIG. 1 and another SP system through Internet/intranet 240 (if it is based on a regular Ethernet Interconnect) may only occur at an MTU of 1500 bytes. The present invention provides a mechanism by which data transfers between two SP switches via a regular Ethernet interconnect may be improved.

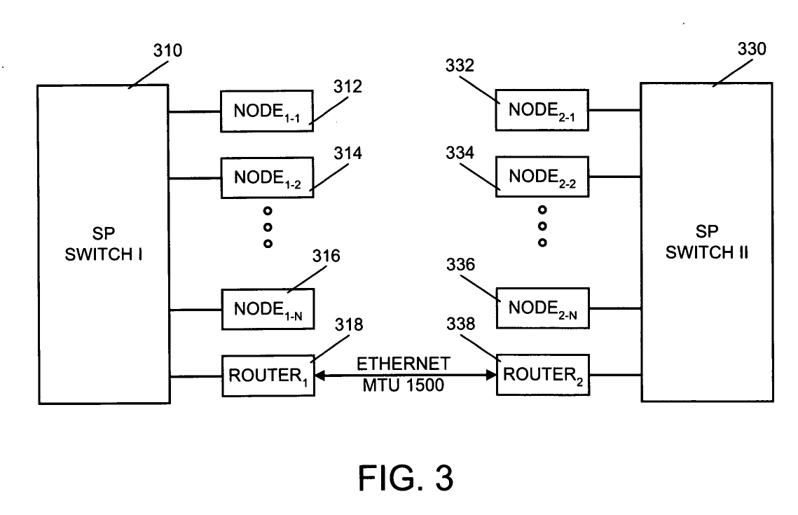

FIG. 3 depicts a network of two SP systems that is based on an Ethernet interconnect. As mentioned before, the network may be the Internet or an intranet or any other network so long as it is based on an interconnect that transacts data at a relatively much slower speed than the speed with which data is transacted within the systems. The network contains two SP switches (i.e., two SP systems). SP switch 1310 has attached thereto a plurality of nodes (i.e., node₁₋₁ 312, node₁₂ 314 through nodelN 316, N being an integer) and a router₁ 318. Likewise SP switch II 330 has attached thereto a plurality of nodes (i.e., node₂₁ 332, node₂₋₂ 334 through node_{2-N} 336, again N being an integer) and a router₂ 338. Data exchange between the two SP systems occur via a regular Ethernet interconnect supporting an MTU of 1500 bytes.

In the past, when a node from SP system I (e.g., node₁₋₁ 312) wanted to communicate with a node in SP system II (e.g., node₂₋₂ 334), node₁₋₁ 312 had two options. The first option was to turn on path MTU discovery. By doing so, node₁₋₁ 312 would determine that the MTU along the path is 1500. Consequently, node₁₋₁ 312 would break the data up into packets of 1500 bytes or less before sending the data to router₁ 318. Router₁ 318 would then transmit the packets over the Ethernet interconnect to router₂ 338 which would pass the packets to node₂₋₂ 334. Thus, the large bandwidth provided by the 64-Kbyte-MTU would not be utilized. Instead, much smaller packets (1500 bytes or less) would be used, thereby adversely affecting performance.

The second option was for node₁₋₁ 312 to turn off path MTU discovery and send the packets out assuming that the entire path MTU is 64 Kbytes. In this case, however, upon receiving a packet larger than 1500 bytes, router₁ 318, which would be aware that the Ethernet interconnect only supports up to 1500-byte-packets, would break the packet into fragments of 1500 bytes or less. The fragments would be passed to router₂ 338 which in turn would pass them to node₂₋₂ 334. Upon receiving all the fragments, node₂₋₂ 334 would reassemble them back into the original packet. Here then, although the large bandwidth would be exploited within SP system I, it would not be used within SP system II.

The invention uses fragment-reassembling routers (as well as the second option mentioned above) to exploit the large bandwidth available in both SP systems in the network. To continue with the previous example, after router₁ 318 breaks a packet into fragments of 1500 bytes or less, it will send the fragments to router₂ 338. Router₂ 338 will collect the fragments, reassemble them into the original packet and send the reassembled packet to node₂₋₂ 334. Thus, if a packet of 64 kbytes was sent by node₁₋₁ 312 to router₁ 318 within SP system I, after reassembling the fragments into the packet, a packet of 64 kbytes would be sent by router₂ 338 to node₂₋₂ 334 within SP system II.

To use the invention, however, a router must first determine whether the MTU of the outgoing data is much greater (i.e., greater by a factor of three or more, for instance) than the MTU of the incoming data. If so, instead of passing the incoming fragments as they are being received to their destination, the router may collect them, reassemble them into the original packet and send the reassembled packet to its destination. Again to continue with the example above, if router₂ 338 determines that the MTU of the outgoing data (MTU within SP system II) is much greater than the MTU of the incoming data (i.e., MTU of the Ethernet interconnect), which in this case it is, the router₂ 338 may collect the fragments, reassemble them into the original packet and send the packet to node₂₋₂ 334. Note that router₂ 318 will perform a similar function.

Nonetheless, to use the invention, certain rules may need to be followed. For example, a timeout must be specified beyond which fragments may have to be delivered to their destination node instead of a reassembled packet. After all, waiting indefinitely (or for an inordinate amount of time) for a fragment may defeat the purpose of the invention. Further, out-of-order fragments should be sent to the receiving node without re-assembly. This is because fragments may be sent along different paths. For example, if SP switch II 330 represents switch 104 of FIG. 1, then some fragments may go through router₃ (not shown) which may be attached to switch 106 of FIG. 1 to be delivered to node₂₋₂ 334. Therefore, when out-of-order fragments are received, they must be sent out immediately, lest the router waits indefinitely for some of the fragments.

Note that in describing the invention, an outgoing MTU greater than an incoming MTU by a factor of three was used. However, the invention is not thus restricted. For example, an outgoing MTU that is greater than an incoming MTU by a factor of more than or less than three may be used. Thus, the use of an outgoing MTU greater than an incoming MTU by a factor of three is for illustrative purposes only.

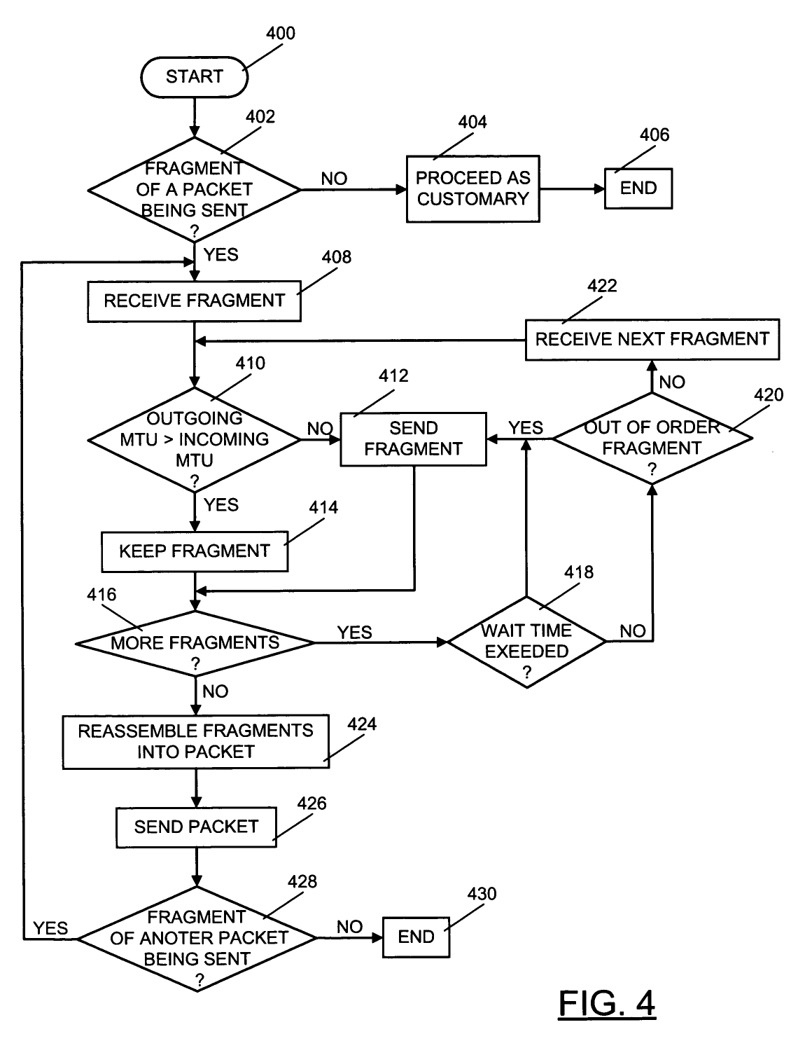

FIG. 4 is a flowchart of a process that may be used to implement the invention. The process starts when data is being received by a reassembling router (step 400). At that time a check will be conducted to determine whether a fragment of a packet is being sent (step 402). This check can easily be done by scrutinizing the IP (Internet Protocol) header of the fragment.

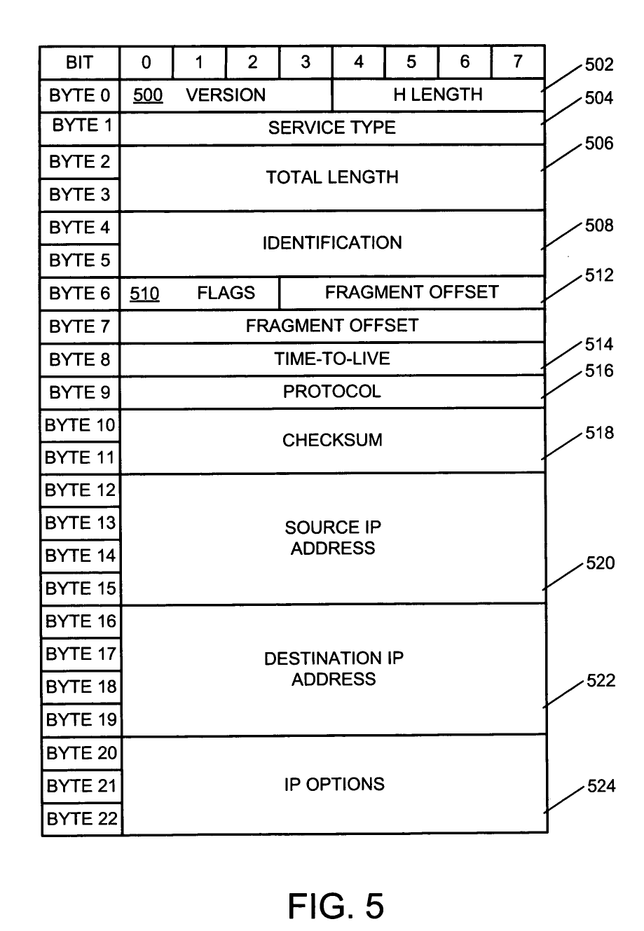

To illustrate, each packet or fragment being sent on a network contains an IP header. FIG. 5 depicts a representative IP header in byte format. Version 500 is the version of the IP protocol used to create the data packet and header length 502 is the length of the header. Service type 504 specifies how an upper layer protocol would like a current data packet handled. Specifically, each data packet is assigned a level of importance. Total length 506 specifies the length, in bytes, of the entire data packet, including the data and header.

IP identification 508 is used when a packet is fragmented into smaller pieces while traversing a network. This identifier is assigned by the transmitting host so that different fragments arriving at the destination host can be associated with each other for re-assembly. For example, if while traversing the network a packet is fragmented by a router, the router will use the IP identification number in the header of the packet with all the fragments. Thus, when the fragments arrive at their destination they can be easily identified.

Flags 510 is used for fragmentation and re-assembly purposes. The first bit is called “More Fragments” (MF) bit and is used to indicate whether the packet is fragmented. For example, if the bit is set in the IP header of a current fragment, then there is at least one fragment that follows the current fragment. If the bit is not set, the current fragment is not followed by another fragment and the receiver may begin re-assembling the packet. The second bit is the “Do not Fragment” (DF) bit, which suppresses fragmentation. The third bit is unused and is always set to zero (0).

Fragment Offset 512 indicates the position of the fragment in the original packet. In the first packet of a fragment stream, the offset will be zero (0). In subsequent fragments, this field indicates the offset in increments of 8 bytes. Thus, it allows the destination IP process to properly reconstruct the original data packet.

Time-to-Live 514 maintains a counter that gradually decrements each time a router handles the data packet. When it is decremented down to zero (0), the data packet is discarded. This keeps data packets from looping endlessly on the network. Protocol 516 indicates which upper-layer protocol (e.g., TCP, UDP etc.) is to receive the data packets after IP processing has completed at the destination host. Checksum 518 helps ensure the IP header integrity. Source IP Address 520 specifies the transmitting host and destination IP Address 522 specifies the receiving host. Options 524 allows IP to support various options (e.g., security).

Returning to FIG. 4, the check in step 402 may be done by scrutinizing Flags 510. Particularly, if the bit in Flags 510 is set, then the data being received is a fragment of a packet. If it is not a fragment, then the data is processed as customary before the process ends (steps 404 and 406). If however, the data is a fragment of a packet, the reassembling router will receive the fragment (step 408) and then check to see whether the outgoing MTU is greater than the incoming MTU (step 410). If so, the router will keep the fragment and wait for more fragments (steps 414 and 416). While waiting for more fragments, the router will be mindful that the timeout is not exceeded. If it is exceeded, the router will send the fragment to its destination. Further, the router will check that the fragment is not an out-of-order fragment. This can be checked by scrutinizing fragment offset 512. Out-of-order fragments are sent right away to their destination. If it is not an out-o-order fragment, it will be collected and when all the fragments are received, the router will reassemble them into the original packet and send the packet to its destination (steps 416, 418, 420, 422, 424 and 426).

After sending the packet to its destination, the router may check to see whether fragments of another packet are being sent. If so, the process jumps back to step 408; otherwise, the process ends (steps 428 and 430). Incidentally, the check in step 410 may be done only once (i.e., the first time the router receives fragments after being initialized).

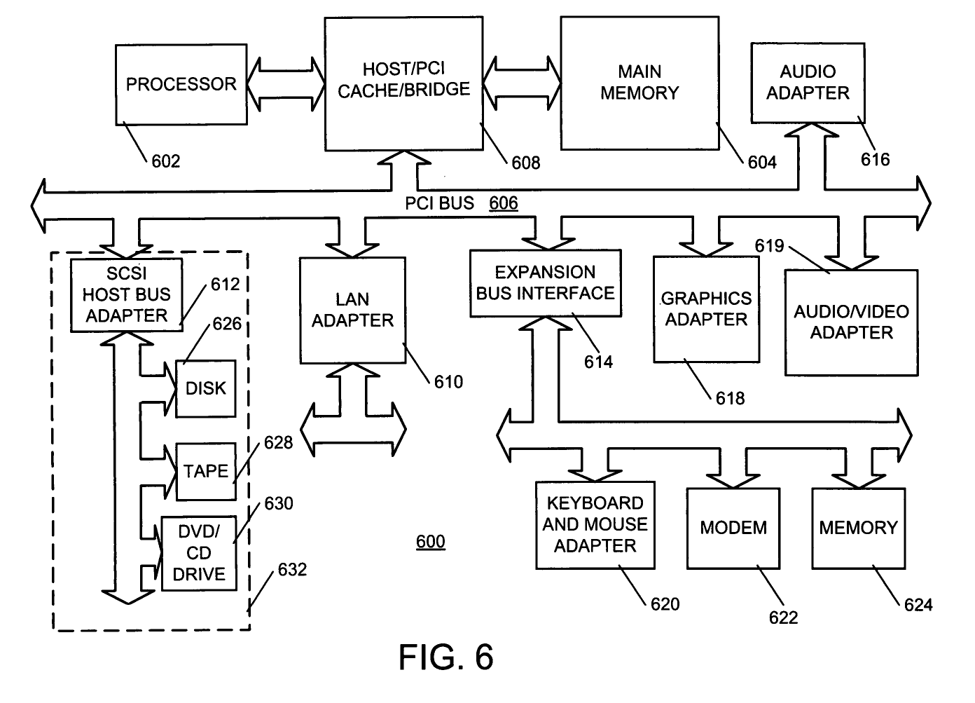

With reference now to FIG. 6, a block diagram illustrating a data processing system is depicted in which the present invention may be implemented. Data processing system 600 is an example of a client computer. Data processing system 600 employs a peripheral component interconnect (PCI) local bus architecture. Although the depicted example employs a PCI bus, other bus architectures such as Accelerated Graphics Port (AGP) and Industry Standard Architecture (ISA) may be used. Processor 602 and main memory 604 are connected to PCI local bus 606 through PCI bridge 608. PCI bridge 608 also may include an integrated memory controller and cache memory for processor 602. Additional connections to PCI local bus 606 may be made through direct component interconnection or through add-in boards. In the depicted example, local area network (LAN) adapter 610, SCSI host bus adapter 612, and expansion bus interface 614 are connected to PCI local bus 606 by direct component connection. In contrast, audio adapter 616, graphics adapter 618, and audio/video adapter 619 are connected to PCI local bus 606 by add-in boards inserted into expansion slots. Expansion bus interface 614 provides a connection for a keyboard and mouse adapter 620, modem 622, and additional memory 624. Small computer system interface (SCSI) host bus adapter 612 provides a connection for hard disk drive 626, tape drive 628, and CD-ROM/DVD drive 630. Typical PCI local bus implementations will support three or four PCI expansion slots or add-in connectors.

An operating system runs on processor 602 and is used to coordinate and provide control of various components within data processing system 600 in FIG. 6. The operating system may be a commercially available operating system, such as Windows XP™, which is available from Microsoft Corporation. An object oriented programming system such as Java may run in conjunction with the operating system and provide calls to the operating system from Java programs or applications executing on data processing system 600. “Java” is a trademark of Sun Microsystems, Inc. Instructions for the operating system, the object-oriented operating system, and applications or programs as well as the invention may be located on storage devices, such as hard disk drive 626, and may be loaded into main memory 604 for execution by processor 602.

Those of ordinary skill in the art will appreciate that the hardware in FIG. 6 may vary depending on the implementation. Other internal hardware or peripheral devices, such as flash ROM (or equivalent nonvolatile memory) or optical disk drives and the like, may be used in addition to or in place of the hardware depicted in FIG. 6. Also, the processes of the present invention may be applied to a multiprocessor data processing system.

The depicted example in FIG. 6 and above-described examples are not meant to imply architectural limitations. For example, data processing system 600 may also be a notebook computer or hand held computer or kiosk or a Web appliance.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of improving network data traffic between interconnected high-speed switches comprising the steps of:
receiving data sent to a sub-network, the data being a fragment of a packet of a particular length;
comparing the length of the fragment with a maximum length of data allowed by the sub-network;
collecting, if the maximum length of the data allowed by the sub-network is greater than the length of the fragment, all the fragments of the packet;
reassembling the fragments into the packet; and
transferring the packet to its destination.

2. The method of claim 1 wherein if all the fragments are not received within a predefined time, the fragments are sent to their destination without being reassembled into the packet.

3. The method of claim 1 wherein out-of-order fragments are sent to their destination without being reassembled into the packet.

4. The method of claim 1 wherein the fragments are reassembled into the packet if the maximum length of the data allowed by the sub-network is greater than the length of the fragment by a pre-defined threshold.

5. A method of improving network data traffic between interconnected high-speed switches comprising the steps of:
receiving data sent to a sub-network, the data being of a certain length;
comparing the length of the data with a maximum length of data allowed by the sub-network;
collecting, if the maximum length of data allowed by the sub-network is greater than the length of the data, different pieces of data being sent to the sub-network;
combining the different pieces of data to coincide to the maximum length of the data; and
transferring the combined pieces of data.

6. A computer program product on a computer readable medium for improving network data traffic between interconnected high-speed switches comprising:
code means for receiving data sent to a sub-network, the data being a fragment of a packet of a particular length;
code means for comparing the length of the fragment with a maximum length of data allowed by the sub-network;
code means for collecting, if the maximum length of the data allowed by the sub-network is greater than the length of the fragment, all the fragments of the packet;
code means for reassembling the fragments into the packet; and
code means for transferring the packet to its destination.

7. The computer program product of claim 6 wherein if all the fragments are not received within a predefined time, the fragments are sent to their destination without being reassembled into the packet.

8. The computer program product of claim 6 wherein out-of-order fragments are sent to their destination without being reassembled into the packet.

9. The computer program product of claim 6 wherein the fragments are reassembled into the packet if the maximum length of the data allowed by the sub-network is greater than the length of the fragment by a pre-defined threshold.

10. A computer program product on a computer readable medium for improving network data traffic between interconnected high-speed switches comprising:
code means for receiving data sent to a sub-network, the data being of a certain length;
code means for comparing the length of the data with a maximum length of data allowed by the sub-network;
code means for collecting, if the maximum length of data allowed by the sub-network is greater than the length of the data, different pieces of data being sent to the sub-network;
code means for combining the different pieces of data to coincide to the maximum length of the data; and
code means for transferring the combined pieces of data.

11. An apparatus for improving network data traffic between interconnected high-speed switches comprising:
means for receiving data sent to a sub-network, the data being a fragment of a packet of a particular length;
means for comparing the length of the fragment with a maximum length of data allowed by the sub-network;
means for collecting, if the maximum length of the data allowed by the sub-network is greater than the length of the fragment, all the fragments of the packet;
means for reassembling the fragments into the packet; and
means for transferring the packet to its destination.

12. The apparatus of claim 11 wherein if all the fragments are not received within a predefined time, the fragments are sent to their destination without being reassembled into the packet.

13. The apparatus of claim 11 wherein out-of-order fragments are sent to their destination without being reassembled into the packet.

14. The apparatus of claim 11 wherein the fragments are reassembled into the packet if the maximum length of the data allowed by the sub-network is greater than the length of the fragment by a pre-defined threshold.

15. An apparatus for improving network data traffic between interconnected high-speed switches comprising:
means for receiving data sent to a sub-network, the data being of a certain length;
means for comparing the length of the data with a maximum length of data allowed by the sub-network;
means for collecting, if the maximum length of data allowed by the sub-network is greater than the length of the data, different pieces of data being sent to the sub-network;
means for combining the different pieces of data to coincide to the maximum length of the data; and
means for transferring the combined pieces of data.

16. A system for improving network data traffic between interconnected high-speed switches comprising:
at least one storage device for storing code data; and
at least one processor for processing the code data to receive data sent to a sub-network, the data being a fragment of a packet of a particular length, to compare the length of the fragment with a maximum length of data allowed by the sub-network, to collect, if the maximum length of the data allowed by the sub-network is greater than the length of the fragment, all the fragments of the packet, to reassemble the fragments into the packet, and to transfer the packet to its destination.

17. The system of claim 16 wherein if all the fragments are not received within a predefined time, the fragments are sent to their destination without being reassembled into the packet.

18. The system of claim 16 wherein out-of-order fragments are sent to their destination without being reassembled into the packet.

19. The system of claim 16 wherein the fragments are reassembled into the packet if the maximum length of the data allowed by the sub-network is greater than the length of the fragment by a pre-defined threshold.

20. A system for improving network data traffic between interconnected high-speed switches comprising:
at least one storage device for storing code data; and
at least one processor for processing the code data to receive data sent to a sub-network, the data being of a certain length, to compare the length of the data with a maximum length of data allowed by the sub-network, to collect, if the maximum length of data allowed by the sub-network is greater than the length of the data, different pieces of data being sent to the sub-network, to combine the different pieces of data to coincide to the maximum length of the data, and to transfer the combined pieces of data.
